(19) United States
(12) Patent Application Publication
(10) Pub. No.: US 2008/0086567 A1
(43) Pub. Date: Apr. 10, 2008

(54) SIP server architecture for improving latency in message processing

(75) Inventors: Anno R. Langen, Berkeley, CA (US); Reto Kramer, Berkeley, CA (US); David Connelly, San Francisco, CA (US); Rao Nasir Khan, Fremont, CA (US); John Beatty, Redwood City, CA (US); Ioannis Cosmadopoulos, San Francisco, CA (US); Manoj Cheenath, San Ramon, CA (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/545,671

(22) Filed: Oct. 10, 2006

(51) Int. Cl. G06F 15/16

(52) U.S. Cl. 709/230

(57) ABSTRACT

The SIP server can be comprised of an engine tier and a state tier distributed on a cluster network environment. The engine tier can send and receive messages and execute various processes. The state tier can maintain in-memory state data associated with various SIP sessions. For example, the state tier can store various long lived data objects and the engine tier can contain short lived data objects. The state data can be maintained in partitions comprised of state replicas. A load balancer can receive incoming message traffic and distribute it to the engine tier for processing. When processing a message, the engine can pull state data objects from the state tier, use the objects and push them back to the state tier after processing is complete. If one state replica is unavailable, such as during garbage collection, the engine can retrieve the objects from another replica in the partition.

### CROSS REFERENCE TO RELATED APPLICATIONS

The following commonly owned, co-pending United States patents and Patent Applications, including the present application, are related to each other. Each of the other patents/applications are incorporated by reference herein in their entirety:

U.S. patent application Ser. No. 11/378,188, entitled SYSTEM AND METHOD FOR MANAGING COMMUNICATIONS SESSIONS IN A NETWORK, by Reto Kramer, et al., filed on Mar.17, 2006 (Attorney Docket No. BEAS-1744US1);

U.S. patent application Ser. No. 11/384,056, entitled SYSTEM AND METHOD FOR A GATEKEEPER IN A COMMUNICATIONS NETWORK, by Reto Kramer, et al., filed on Mar. 17, 2006 (Attorney Docket No. BEAS-1962US1);

U.S. Provisional Patent Application No. 60/801,091 entitled SIP AND HTTP CONVERGENCE IN NETWORK COMPUTING ENVIRONMENTS, by Anno Langen, et al., filed on May 16, 2006 (Attorney Docket No. BEAS-2060US0);

U.S. Provisional Patent Application No. 60/800,943 entitled HITLESS APPLICATION UPGRADE FOR SIP SERVER ARCHITECTURE, by Anno Langen et al., filed on May 16, 2006 (Attorney Docket No. BEAS-2061US0);

U.S. Provisional Patent Application No. 60/801,083 entitled ENGINE NEAR CACHE FOR REDUCING LATENCY IN A TELECOMMUNICATIONS ENVIRONMNENT by Anno Langen, et al., filed on May 16, 2006 (Attorney Docket No. BEAS-2062US0);

U.S. patent application Ser. No. 11/434,022 entitled SYSTEM AND METHOD FOR CONTROLLING DATA FLOW BASED UPON A TEMPORAL POLICY, by Narendra Vemula, et al., filed on May 15, 2006 (Attorney Docket No. BEAS-2064US0);

U.S. patent application Ser. No. 11/434,024 entitled SYSTEM AND METHOD FOR CONTROLLING ACCESS TO LEGACY PUSH PROTOCOLS BASED UPON A POLICY, by Bengt-Inge Jakobsson, et al., filed on May 15, 2006 (Attorney Docket No. BEAS-2066US0);

U.S. patent application Ser. No. 11/434,010 entitled SYSTEM AND METHOD FOR CONTROLLING ACCESS TO LEGACY MULTIMEDIA MESSAGE PROTOCOLS BASED UPON A POLICY, by Andreas Jansson, filed on May 15, 2006 (Attorney Docket No. BEAS-2067US0);

U.S. patent application Ser. No. 11/434,025 entitled SYSTEM AND METHOD FOR CONTROLLING ACCESS TO LEGACY SHORT MESSAGE PEER-TO-PEER PROTOCOLS BASED UPON A POLICY, by Andreas Jansson, filed on May 15, 2006 (Attorney Docket No. BEAS-2068US0);

U.S. patent application Ser. No. 11/432,934 entitled SYSTEM AND METHOD FOR SHAPING TRAFFIC, by Jan Svensson, filed on May 12, 2006 (Attorney Docket No. BEAS-2070US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to managing telecommunications and more particularly to providing an SIP server for processing messages in a network environment.

### BACKGROUND

Conventionally, telecommunications and network infrastructure providers have relied on often decades old switching technology to providing routing for network traffic. Businesses and consumers, however, are driving industry transformation by demanding new converged voice, data and video services. The ability to meet these demands often can be limited by existing IT and network infrastructures that are closed, proprietary and too rigid to support these next generation services. As a result, telecommunications companies are transitioning from traditional, circuit-switched Public Switched Telephone Networks (PSTN), the common wired telephone system used around the world to connect any one telephone to another telephone, to Voice Over Internet Protocol (VoIP) networks. VoIP technologies enable voice communication over “vanilla” IP networks, such as the public Internet. Additionally, a steady decline in voice revenues has resulted in heightened competitive pressures as carriers vie to grow data/service revenues and reduce churn through the delivery of these more sophisticated data services. Increased federal regulation, security and privacy issues, as well as newly emerging standards can further compound the pressure.

However, delivering these more sophisticated data services has proved to be more difficult than first imagined. Existing IT and network infrastructures, closed proprietary network-based switching fabrics and the like have proved to be too complex and too rigid to allow the creation and deployment of new service offerings. Furthermore, latency has been an important issue in addressing the processing of telecommunications, as more and more users expect seemingly instantaneous access from their devices.

### BRIEF DESCRIPTION OF THE DRAWINGS

FIG. 1A is an exemplary illustration of a functional system layers in various embodiments.

FIG. 1B is another exemplary illustration of functional system layers in a communications platform embodiment.

FIG. 1C is an exemplary illustration of a SIP server deployed in a production environment, in accordance with various embodiments.

FIG. 2 is an exemplary illustration of the SIP server cluster architecture in accordance with various embodiments of the invention.

FIG. 3 is another exemplary illustration of SEP server cluster architecture in accordance with various embodiments of the invention.

FIG. 4A is an exemplary flow diagram of the SIP server message processing, in accordance with various embodiments.

FIG. 4B is an exemplary flow diagram of a retrieving state from the state tier, in accordance with various embodiments.

FIG. 5 is an exemplary illustration of a simplified call flow in a typical SIP communication session, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments, there are provided systems and methods for improving latency in message processing for a network environment via the use of SIP server architecture. In various embodiments, the SIP server can be comprised of an engine tier and a state tier distributed on a cluster network environment. The engine tier can send and receive messages and execute various processes. The state tier can maintain in-memory state data associated with various SIP sessions. For example, the state tier can store various long lived (stateful) data objects and the engine tier can contain short lived data (stateless) objects. The state data can be maintained in partitions comprised of state replicas. A load balancer can receive incoming message traffic and distribute it to the engine tier for processing. When processing a message, the engine can pull state data objects from the state tier, use the objects and push them back to the state tier after processing is complete. If one state replica is unavailable, such as during garbage collection, the engine can retrieve the objects from another replica in the partition.

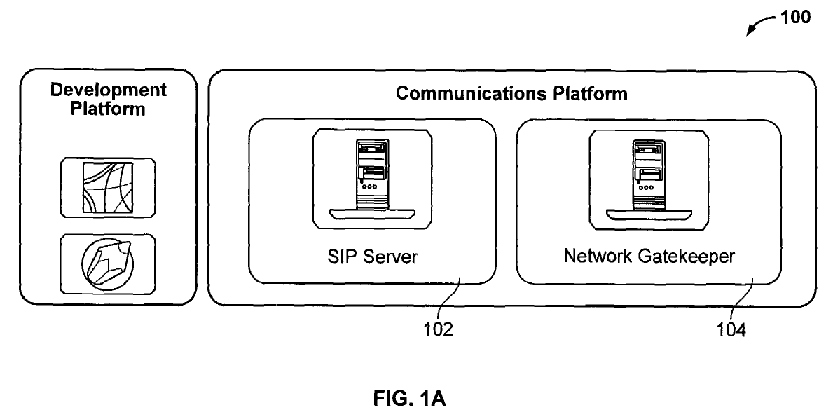

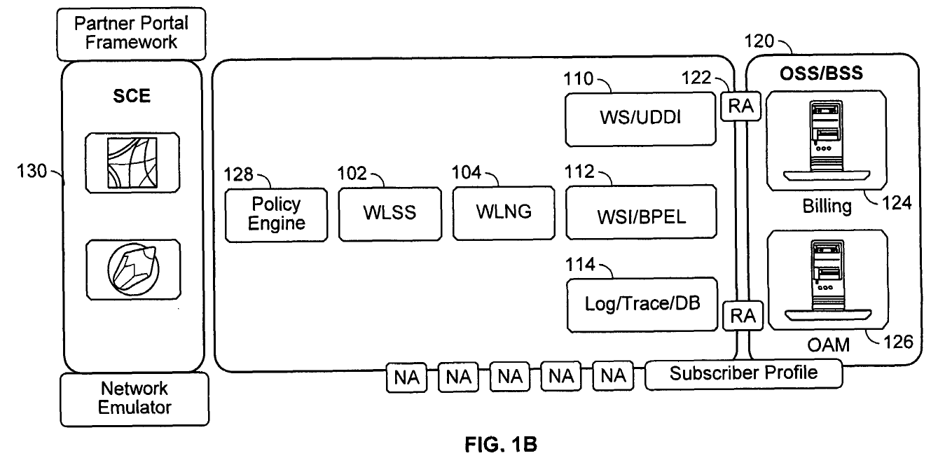

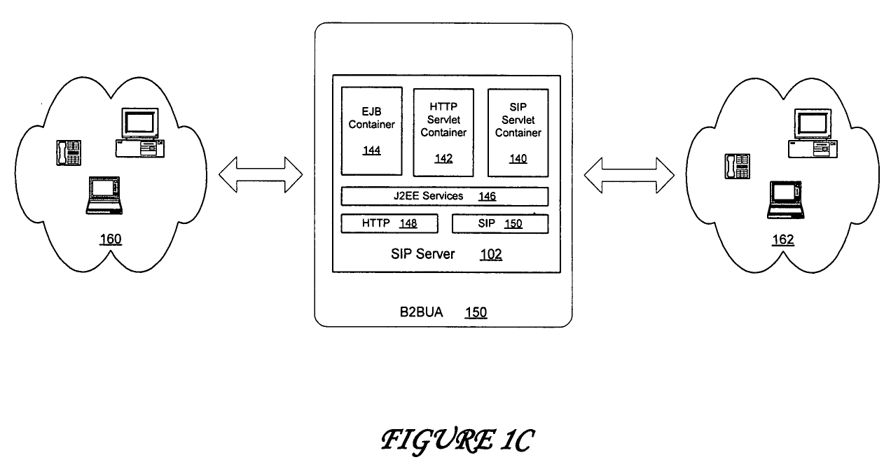

FIG. 1A is an exemplary illustration of functional system layers in various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

A Session Initiation Protocol (SIP) Server 102 and a Network Gatekeeper 104 can comprise a portfolio of products that collectively make up the Communications Platform 100. The SIP Server 102 provides the Communications Platform 100 with a subsystem in which application components that interact with SIP-based networks may be deployed. The Network Gatekeeper 104 provides a policy-driven telecommunications Web services gateway that allows granular control over access to network resources from un-trusted domains.

A variety of shared and re-usable software and service infrastructure components comprise the Communications Platform 100. For example, an Application Server, such as the WebLogic™ Application Server by BEA Systems, Inc. of San Jose, Calif. This Application Server may be augmented and adapted for deployment in telecommunications networks, while providing many features and functionality of the WebLogic Server counterpart widely deployed in enterprise computing environments. Application Server embodiments for use in the telecommunications applications can provide a variety of additional features and functionality, such as without limitation:
Optimized for Peak Throughput
Clustering for Scalability and High-Performance
Generalized for wide range of target platforms (HW/OS) support
Extensive deployment configuration options
Optimized for local management
Plug and play Enterprise Information Systems (EIS) support

Analogously, communications platform embodiments can provide a variety of additional features and functionality, such as without limitation:
Highly Deterministic Runtime Environment
Clustering for High-Availability (HA) and Scalability
Optimized for Telecom HW/OS/HAM W platforms support (SAF, ATCA, HA M/W, etc.)
Hardened configuration
Optimized for Telecom NMS integration
Telecommunications network connectors and interfaces
Partitioning, replication and failover

FIG. 1B is another exemplary illustration of functional system layers in a communications platform embodiment. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

Communications platform 100 comprises a SIP Server (WLSS) 102 and a Network Gatekeeper (WLNG) 104. Tools for interacting with Web Services, such as a Web Service—Universal Description Discovery Interface (WS/UDDI) 110, a Web Service—Business Process Execution Language (WS/BPEL) 112 may be coupled to the SIP Server 102 and the Network Gatekeeper 104 in embodiments. A log/trace and database 114 can assist with troubleshooting. In some deployments, the Communications Platform 100 can interface with an OSS/BSS system 120 via resource adapters 122. Such interfaces can provide access to billing applications 124, Operation, Administration, and Maintenance (OAM) applications 126 and others. A policy engine 128 can control the activities of the above-described components which can be implemented in a scalable cluster environment (SCE) 130.

A Communications Platform embodiment can provide an open, high performance, software based fault-tolerant platform that allows operators to maximize revenue potential by shortening time to market and significantly reducing per-service implementation and integration cost and complexity. The Communications Platform is suitable for use by for Network Infrastructure Vendor, Network Operators and Communications Service Providers in multiple deployment scenarios ranging from fully IMS oriented network architectures to hybrid and highly heterogeneous network architectures. It is not restricted to use only in carrier networks, however, and may be deployed in Enterprise communications networks without restriction or extensive customization. When deployed in conjunction with an IP Multimedia Subsystem, the Communications Platform can serve in the role of an IMS SIP Application Server and offers Communications Service Providers an execution environment in which to host applications (such as the WebLogic Network Gatekeeper), components and standard service enablers.

FIG. 1C is an exemplary illustration of a SIP server deployed in a production environment, in accordance with various embodiments. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, the SIP server 102 can be used as a back-to-back user agent (B2BUA) 150 in a typical telecommunications environment. A B2BUA can take the place of an intermediary between communications between user agents 160, 162, including various cellular phones, wireless devices, laptops, computers, applications, and other components capable of communicating with one another electronically. The B2BUA 150 can provide multiple advantages, including controlling the flow of communication between user agents, enabling different user agents to communicate with one another (e.g. a web application can communicate with a cellular phone), as well as various security advantages. As an illustration, the user agents can transmit to the SIP server instead of communicating directly to each other and thus malicious users can be prevented from sending spam and viruses, hacking into other user agent devices, and otherwise compromising security.

The SIP server 102 can be implemented as a Java Enterprise Edition application server that has been extended with support for the session initiation protocol (SIP) as well as other operational enhancements that allow it to meet the demanding requirements of the next generation protocol-based communication networks. In one embodiment, the SIP server 102 can include an Enterprise Java Beans (EJB) container 144, a Hyper Text Transfer Protocol (HTTP) servlet container 142, an SIP servlet container 140, various Java 2 Enterprise Edition (J2EE) services 146, and SIP 150 and HTTP 148 components. The SIP stack of the server can be fully integrated into the SIP servlet container 140 and can offer much greater ease of use than a traditional protocol stack. A SIP servlet Application Programming Interface (API) can be provided in order to expose the full capabilities of the SIP protocol in the Java programming language. The SIP servlet API can define a higher layer of abstraction than simple protocol stacks provide and can thereby can free up the developer from concern about the mechanics of the SIP protocol itself. For example, the developer can be shielded from syntactic validation of received requests, handling of transaction layer timers, generation of non application related responses, generation of fully-formed SIP requests from request objects (which can involve correct preparation of system headers and generation of syntactically correct SIP messages) and handling of lower-layer transport protocols such as TCP, UDP or SCTP.

In one embodiment, the container is a server software that hosts applications (i.e. contains them). In the case of a SIP container, it hosts SIP applications. The container can perform a number of SIP functions as specified by the protocol thereby taking the burden off the applications. At the same time, the SIP container can expose the application to SIP protocol messages (via the SIP Servlet API) on which applications can perform various actions. Different applications can thus be coded and deployed to the container that provides various telecommunication and multimedia services.

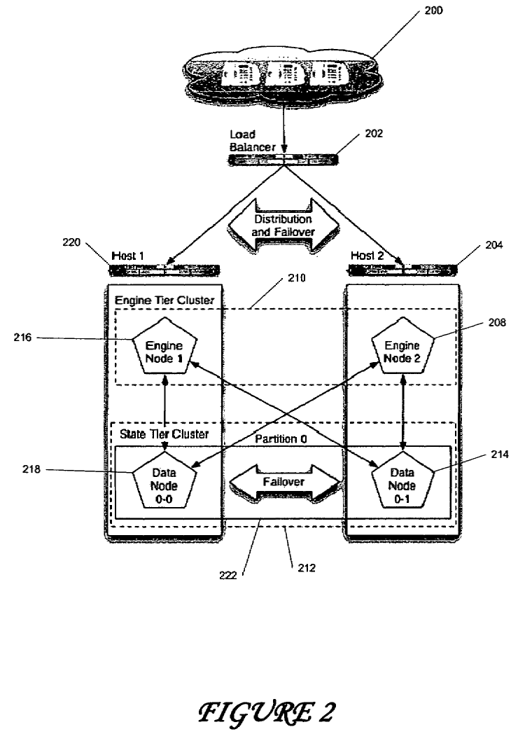

FIG. 2 is an exemplary illustration of the SIP server cluster architecture in accordance with various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means. For example, while the FIG. 2 shows Host A implementing both an engine node and a data node, this should not be construed as limiting the invention. In many cases, it can be preferable to distribute the engine node and data node onto separate host machines. Similarly, while FIG. 2 illustrates two host machines, it is possible and even advantageous to implement many more such hosts in order to take advantage of distribution, load balancing and failover that such a system can provide.

As illustrated, a message, such as a phone call request or some other transfer of data associated with SIP, can come into the cluster from the internet (such as over VoIP), phone, or some other type of network 200. This message can be received and handled by a load balancer 202 which can be responsible distributing message traffic across the engines (such as engine node 1 216 and engine node 2 208) in the cluster. The load balancer can be a standard load balancing appliance hardware device and it is not necessary that it be SIP aware; there is no requirement that the load balancer support affinity between the engines 216, 208, and SIP dialogs or transactions. Alternatively, the load balancer can be implemented as software that distributes the messages to the various engines. In the various embodiments, the primary goal of the load balancer 202 can be to provide a single public address that distributes incoming SIP requests to available servers in the SIP server engine tier 210. Such distribution of requests can ensure that the SIP server engines are fully utilized. The load balancer 202 can also be used for performing maintenance activities such as upgrading individual servers or applications without disrupting existing SIP clients.

In one embodiment, the SIP server can provide a two-tier cluster architecture model to handle the incoming messages. In this model, a stateless engine tier 210 can process all signaling traffic and can also replicate transaction and session state to the state tier 212 and its partitions 222. Each partition 222 can consist of any number of nodes (replicas) 218, 214 distributed across any number of hosts such as host 1 220 and host 2 204 which can be implemented as computers linked in a cluster type network environment. The state tier 212 can be an n-way peer-replicated Random Access Memory (RAM) store that maintains various data objects which can be accessed by the engine nodes in the engine tier. In this manner, engines can be provided a dual advantage of faster access to the data objects than retrieving data from a database while at the same time, engines can be freed up from having to store the data onto the engine tier itself. This type of separation can offer various performance improvements. The state tier can also function as a lock manager where call state access follows a simple library book model, (i.e. a call state can be checked out by one SIP engine at a time).

The engine tier 210 can be implemented as a cluster of SIP server instances that hosts the SIP servlets which provide various features to SIP clients. In one embodiment, the engine tier 210 is stateless, meaning that most SIP session state information is not persisted in the engine tier, but is obtained by querying the state tier 212 which can in turn provide replication and failover services for SIP session data.

The primary goal of the engine tier 210 can be to provide maximum throughput combined with low response time to SIP clients. As the number of calls or their duration increases, more server instances can be added to the engine tier to manage the additional load. It should be noted however, that although the engine tier may include many such server instances, it can be managed as a single, logical entity. For example, the SIP servlets can be deployed uniformly to all server instances by targeting the cluster itself and the load balancer need not maintain affinity between SIP clients and individual servers in the engine tier.

In various embodiments, the state tier 212 can be implemented as a cluster of SIP server instances that provides a high-performance, highly-available, in-memory store for maintaining and retrieving session state data for SIP servlets. This session data may be required by SIP applications in the SIP server engine tier 210 in order to process incoming messages. Within the state tier 212, session data can be managed in one or more partitions 222, where each partition manages a fixed portion of the concurrent call state. For example, in a system that uses two partitions, the first partition could manage one half of the concurrent call state (e.g. A-M) and the second partition can manage the other half (e.g. N-Z). With three partitions, each can manage a third of the call state and so on. Additional partitions can be added as needed to manage large number of concurrent calls.

In one embodiment, within each partition 222, multiple servers can be added to provide redundancy and failover should the other servers in the partition fail. When multiple servers participate in the same partition 222, those servers can be referred to as replicas because each server maintains a duplicate copy of the partition's call state. For example, nodes 218 and 214 of the partition 222 can be implemented as replicas. Furthermore, to increase the capacity of the state tier 212, the data can be split evenly across a set of partitions, as previously discussed. The number of replicas in the partition can be called the replication factor, since it determines the level of redundancy and strength of failover that it provides. For example, if one node goes down or becomes disconnected from the network, any available replica can automatically provide call state data to the engine tier.

Replicas 214, 218 can join and leave the partition 222 and each replica can serve as exactly one partition at a time. Thus, in one embodiment, the total available call state storage capacity of the cluster is a summation of the capacities of each partition 222.

In one embodiment, each partition 222 can peer-replicated, meaning that clients perform all operations (reads/writes) to all replicas 218, 214 in the partition (wherein the current set of replicas in the partition is called the partition view). This can provide improved latency advantages over more traditional synchronous “primary-secondary” architecture wherein one store acts as a primary and the other nodes serve as secondaries. Latency is reduced because there is no wait for the second hop of primary-secondary systems. The peer-replicated scheme can provide better failover characteristics as well, since there does not need to be change propagation delay.

In one embodiment, the engine nodes 208, 216 can be responsible for executing the call processing. Each call can have a call state associated with it. This call state can contain various information associated with the call, such as the ids of the caller/callee, where the caller is, what application is running on the callee, as well as any timer objects that may need to fire in order to process the call flow as discussed below. The state for each call can be contained in the state tier 212. The engine tier 210, on the other hand, could be stateless in order to achieve the maximum performance. In alternative embodiments, the engine tier can have small amounts of state data stored thereon at various times.

In one embodiment, a typical message processing flow can involve locking/getting the call state, processing the message and putting/unlocking the call state. The operations supported by the replicas for normal operations can include:
lock and get call state
put and unlock call state
lock and get call states with expired timers

In various embodiments, the state tier 212 can maintain call state in various data objects residing in the random access memory (RAM) of a computer. This can provide significant access speed advantages to the engine tier 210. Alternatively, if latency is not an issue, call state can be maintained in a database or some other form of persistent store, which can be accessed (albeit slower) by the engine tier. State of various applications running on the SIP server can also be maintained on the state tier. Developers can be provided an API to allow their applications to access the state tier and to store various data thereon for later access by various applications. Alternatively, application state may be stored in a database.

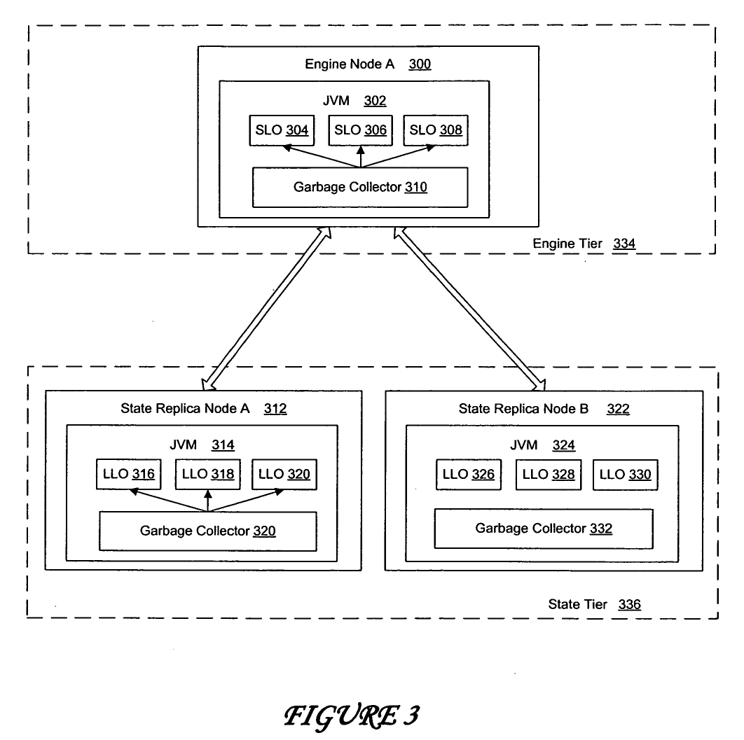

FIG. 3 is another exemplary illustration of SIP server cluster architecture in accordance with various embodiments of the invention. Although this diagram depicts components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication means.

As illustrated, Engine Node A 300 can be implemented as a computer server connected to a network and having a Java Virtual Machine (JVM) 302 on it. A garbage collector 310 can be running on the JVM 302 and can collect unused objects by reclaiming storage space used by those objects. There several garbage collection algorithms that can be implemented for the clearing of the heap. For example, one type of algorithm can quickly remove short-lived objects (SLOs) from the new generation heap. Another type of algorithm can employ a slower and more robust technique to collect longer-lived objects (LLOs) from the old generation heap. As a nonlimiting example, short-lived objects can be the objects instantiated by a single thread and localized to that thread in scope. Thus, in one embodiment, short-lived objects typically exist in a different (more localized) scope than the long-lived objects. This allows the garbage collector to quickly remove the SLOs after the thread is finished using them, without stopping the execution of various other threads and without worrying that their removal might cause inconsistencies, etc. Longer-lived objects, on the other hand, may be thought of as being more global (e.g. referenced by some other entities) and as such, the garbage collector typically stops thread execution in order to clean them up. In some embodiments, this can introduce latency since the execution of various threads needs to be halted for a period of time while the garbage collector removes the unused LLOs. While in typical web server environments this processing pause may be tolerable, the SIP server environment may be highly sensitive to any latency and as such, garbage collection can interfere with its performance.

In one embodiment, the engine tier 334 (e.g. engine node A 300) can create stateless short lived objects (SLOs) 304, 306, 308, in order to process the various calls and messages coming into the network. The state tier can maintain the stateful long-lived objects (LLOs) 316, 318, 320, 326, 328, 330 in the various state replicas (e.g. state replica node A 312 and state replica node B 322) on a partition. After receiving a message, the engine node A can pull the long lived objects that may be necessary for handling the call from state replica A 312 and use them as short lived objects in the engine tier. For example, in order to support the SIP protocol, certain objects for handling the processing of the calls may, by their definition, need to be long-lived. These objects can be maintained on the state tier in the various replicas and they can be pulled by the engines. After the engine node A 300 is done processing the call, short-lived objects 304, 306, 308 can be safely removed if needed.

Thus, in one embodiment, after receiving a message, the engine node A 300 can pull the LLOs 316, 318, 320 from the JVM 314 running on state replica node A 312 and use these objects as short lived objects (SLOs) 304, 306, 308 in the engine tier while processing the message. After it is finished using the objects, they can be pushed back onto the state replica node A 312 and can be safely thrown out of the engine node A. Once the objects are pushed back onto the state tier, they can also be replicated to state replica node B 322 into objects 326, 328, 330 by its JVM 324.

In various embodiments, this type of system can provide latency advantages. For example, the state tier 336 can perform its longer garbage collection of the long-lived objects without necessarily impacting processing in the engine tier 334. Since the data objects can be replicated on multiple state tier replica nodes, the engine node A 300 can access the objects from either state node while the other state node may be performing its garbage collection (or otherwise be unavailable). Thus, if the garbage collector 320 on state replica node A 312 is performing clean up (and thus state replica A is not performing any threads at that point in time), the engine node A 300 can request the same objects from state replica node B 322 on which the garbage collector 332 may not be executing its cycle. The likelihood that all state tier replicas are performing garbage collection becomes very unlikely as more state tier nodes are added to the cluster. In this manner, latency can be improved considerably.

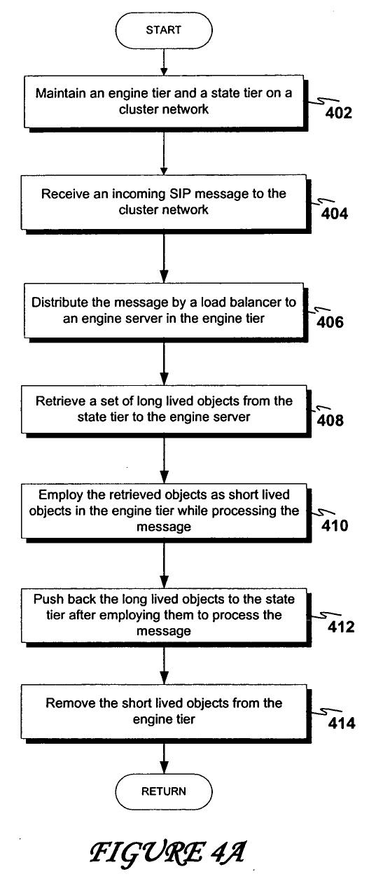

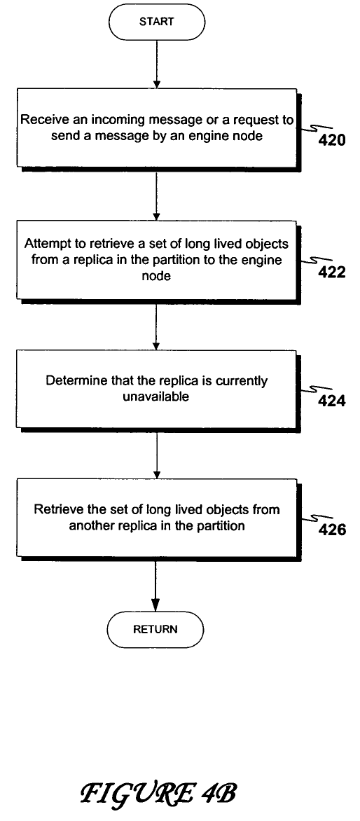

FIG. 4A is an exemplary flow diagram of the SIP server message processing, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As illustrated in step 402, a cluster network of computers can maintain an engine tier and a state tier distributed thereon. The engine tier can create and store short lived objects such as objects that could be safely removed without impacting the execution of other threads. The state tier can store the state associated with an SIP message, including long lived objects which may be used in processing the message.

In step 404, a SIP communication message can be received to the load balancer in the cluster network. The transmission of the message can come in over a communication link such as Ethernet, wireless or a phone line. This SIP message can be generated by various devices or software, such as a cellular phone, a wireless device, a laptop computer, an application, or some other entity which can generate an SIP type of communication.

In step 406, the load balancer can distribute the SIP message to an appropriate engine server node in the engine tier. The load balancer can be a hardware device whose primary goal is to provide a single IP address to the message clients and to distribute the incoming traffic to the engine tier.

In step 408, state data associated with the message can be generated to or retrieved from the state tier. For example, the engine tier server can retrieve a set of long lived objects useful for processing the incoming message from the state tier.

In step 410, the engine server can then employ the set of retrieved long lived objects as short term object versions within the engine tier in order to process the message. The SIP protocol state can be pulled from the state tier to the engine tier and used thereon.

In step 412, after the SIP message has been processed by the engine server, the state can be pushed back onto the state replica in order for the state tier to have current state. Additionally, the new state can be replicated across all replicas in the partition in order to ensure failover.

In step 414, the short lived objects can be removed from the engine tier server in order to free up the engine from having to maintain it there. In this manner, the engine tier can be stateless and can retrieve state from the state tier as messages come up for processing.

FIG. 4B is an exemplary flow diagram of a retrieving state from the state tier, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As illustrated in step 420, an engine can receive incoming message from the load balancer or can receive directions to send a message from the state tier. The engine node can then attempt to retrieve any state useful for processing the message from a replica in an appropriate state tier partition, as illustrated in step 422. For example, the engine tier may need to obtain the long lived objects associated with a SIP message from replica A in the partition 1. In some situations, that replica may be unavailable as is illustrated in step 424. For example, replica A may be busy performing garbage collection and may have ceased processing all requests for a period of time while garbage collection is completed. In that case, the engine server can retrieve the set of long objects from another replica in the partition (e.g. replica B), as shown in step 426. If all replicas are busy, the engine can retry this retrieving process later, after a period of time has lapsed. In this manner, garbage collection need not necessarily impact the performance of the engine tier, since short lived objects can be easily and quickly removed from the state tier without stopping the execution of various threads.

Call Flow

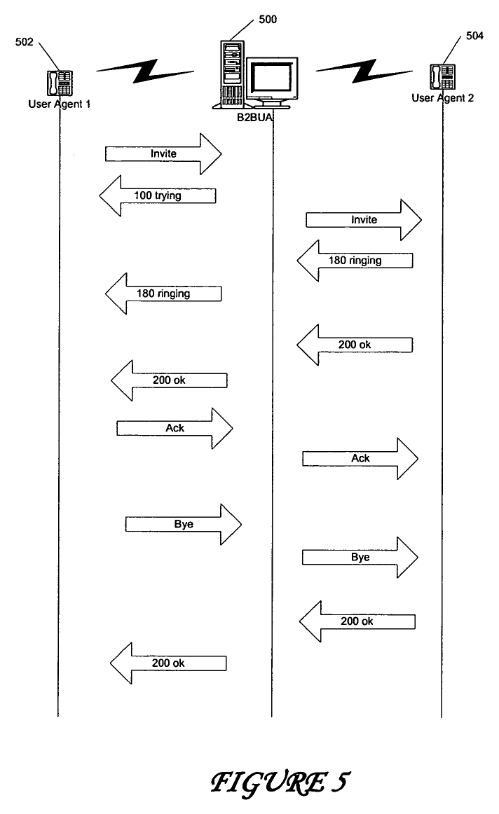

FIG. 5 is an exemplary illustration of a simplified call flow in a typical SIP communication session, in accordance with various embodiments. Although this figure depicts functional steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

As illustrated, a back to back user agent (B2BUA) 500, having a running SIP server thereon can take the place of being an intermediary between the communications sent between various users. This can be done for purposes of controlling the call and message flow between user agent 1 502 and user agent 2 504 and in order to prevent any unwanted behavior and messages (e.g. spamming, hacking, viruses, etc.) from being sent to the user agent device. It should be noted that although user agent 1 502 and user agent 2 504 are illustrated as telephones in FIG. 5, the SIP messages can come from various other sources as well. For example, the user agent can also be a cell phone, a wireless device, a laptop, an application or any other component that can initiate a SIP type of communication. Similarly, while FIG. 5 illustrates communications between two user agents (502, 504), there can be more such user agents taking part of a single communication session. For example, during a conference call, there may be 20 or 30 user agents for all attendees of the conference, each of which could send SIP messages to the B2BUA 500 and receive transmissions back therefrom.

Continuing with the illustration, a telephone call can be set up between user agent 1 502 and user agent 2 504 via the use of the SIP server. The first message sent from user agent 1 502 to the SIP server on the B2BUA 500 can be an invite message, requesting to set up a telephone call with user agent 2 504. The invite message can be received by the load balancer 202 of the SIP server and it can be directed to an engine in the engine tier 210 for processing.

In various embodiments, the engine tier (e.g. an application executing thereon) can then perform logic for determining various factors associated with the call, such as determining whether user agent 1 502 is allowed to make the type of call attempted to be initiated, determining whether the callee that will be contacted is properly identified, as well as any other logic that the server may need to calculate before attempting to set up a telephone call. The engine can then generate state around the fact that a call is being set up, including generating the proper long lived and short lived objects associated with the messages, as previously discussed. The engine can also determine how to find the target of the call (i.e. user agent 2 504) and the right path to route the message to the callee. As illustrated herein, user agent 1 is an originator (as well as the terminator) of the call and user agent 2 is referred to as the callee.

After receiving the invite message, the SIP server can send a “100 trying” message back to user agent 1 502, indicating that it has received the invite message and that it is in the process of handling it. The “100 trying” message is part of the SIP protocol definition and can be used by a server in order to stop the user agent from re-transmitting the invite request. In cellular phone environments, the user agent may have interference which might cause an interruption or loss of various messages. Therefore SIP protocol defines various re-transmission schemes in order to handle such mobility and interruptions. Messages such as “100 trying,” “180 ringing,” and “200 OK” are just some of the examples of messages defined in SIP for handling communication.

Continuing with the illustration, the SIP server can then send an invite message to the user agent 2 504 and can receive back a “180 ringing” message, indicating that user agent 2 504 has received the invitation and is now waiting for a user to answer. The SIP server engine tier can then transmit the “180 ringing” message back to user agent 1 502. When a person finally answers the phone, user agent 2 504 can then send a “200 ok” message to the SIP server, the server can transmit that message to user agent 1 502. The user agent 1 502 can send an acknowledgement (“Ack” message) to the SIP server which can be transmitted along to user agent 2 504 and at this point a sound transfer conversation can be set up between the two user agents. This sound transfer can be implemented via real transfer protocol (RTP) on a media server. At the end of the conversation, either user agent can choose to terminate the call by sending a “Bye” message. In this illustration, user agent 1 502 terminates the call by sending a “Bye” message to the SIP server which sends it off to user agent 2 504. After receiving back a “200 ok” message from user agent 2, the SIP server can transmit that message to user agent 1 and the conversation can be truly ended.

In various embodiments, the vertical lines such as those extending downward from the user agents 502, 504 and the B2BUA 500 can each illustrate and be referred to as a single call leg. The call flow for each call leg may be time sensitive as some messages should be received or sent before others can be initiated. For example, as illustrated herein, the user agent A 502 may continue to re-transmit the initial invite message until it receives a “100 trying” message from the B2BUA 500. As such, in some cases certain messages may need to be processed synchronously while others may be allowed to process in parallel.

It should also be noted that this illustration of a call may be overly simplified for purposes of clarity. For example, there can be various other message transmissions (not illustrated) such as authentication messages for caller/callee, determining the type of user agent the SIP server is communicating with and various other handshaking messages that can be exchanged between the SIP server and the user agents. Furthermore, message transmitting steps may be added, changed, interrupted or rearranged in case of interference or failure of various components.

Timer Objects

As previously discussed, in various embodiments there may be specific sequences of messages exchanged between the SIP server and the user agents for controlling the flow of the call. These sequences can be controlled by various timer objects residing on the SIP server. As a nonlimiting illustration, after receiving the invite message from one user agent, the SIP server will typically forward that invite to another user agent and wait for a response. If no response is received within a period of time (e.g. a number of milliseconds), then the invite message may need to be retransmitted to the second user agent because it may be assumed that the user agent did not receive the first message. This type of re-transmission can be controlled by the protocol timer objects which may be residing in the state tier. In one embodiment, an initial T1 timer value of 500 milliseconds can control the retransmission interval for the invite request and responses and can also set the value of various other timers.

In various embodiments, there are also other timer objects which can be executing on the level of the entire call. For example, if after a specified period of time, nothing is heard back from either user agent, the entire call may be purged from the system. This specified period of time can also be controlled by firing a timer object.

In one embodiment, as engine tier servers add new call state data to the state tier, state tier instances queue and maintain a complete list of SIP protocol timers and application timers associated with each call. Engine tier servers can periodically poll the partitions of the state tier to determine which timers have expired given the current time. In order to avoid contention on the timer tables, multiple engine tier polls to the state tier can be staggered. The engine tier can then process the expired timers using threads in the sip.timer.Default execute queue. Thus, the processing of the timer objects can be executed by the engine server as determined by the state tier server. For example, the state tier can tell the engine A to execute the first half of all due timer objects (e.g. 1-100) and tell engine B to execute the other half (e.g. 101-200). The state tier can also simultaneously push the state onto the engine, since the state may need to be employed in executing the timer objects. The engines can then process the timer objects (e.g. by sending appropriate messages, ending appropriate calls) and can later again query poll the state tier for which timers have become due.

In various embodiments, it may be preferable to synchronize system server clocks to a common time source (e.g. within a few milliseconds) in order achieve maximum performance. For example, an engine tier server with a system clock that is significantly faster than other servers may process more expired timers than the other engine tier servers. In some situations this may cause retransmits to begin before their allotted time and thus care may need to be taken to ensure against it.

In various embodiments, the SIP Servlet API can provide a timer service to be used by applications. There can be TimerService interface which can be retrieved from as a ServletContext attribute. The TimerService can define a “createTimer(SipApplicationSession appSession, long delay, boolean isPersistent, java.io.Serializable info)” method to start an application level timer. The SipApplicationSession can be implicitly associated with the timer. When a timer fires, an application defined TimerListener is invoked and ServletTimer object passed up, through which the SipApplicationSession can be retrieved which provides the right context of the timer expiry.

Failover

In various embodiments, the engine tier servers continually access the state tier replicas in order to retrieve and write call state data. In addition, the engine tier nodes can also detect when a state tier server has failed or become disconnected. For example, in one embodiment, when an engine cannot access or write call state data for some reason (e.g. the state tier node has failed or become disconnected) then the engine can connect to another replica in the partition and retrieve or write data to that replica. The engine can also report that failed replica as being offline. This can be achieved by updating the view of the partition and data tier such that other engines can also be notified about the offline state tier server as they access state data.

Additional failover can also be provided by use of an echo server running on the same machine as the state tier server. The engines can periodically send heartbeat messages to the echo server, which can continually send responses to each heartbeat request. If the echo server fails to respond for a specified period of time, the engines can assume that the state tier server has become disabled and report that state server as previously described. In this manner, even quicker failover detection is provided, since the engines can notice failed servers without waiting for the time that access is needed and without relying on the TCP protocol's retransmission timers to diagnose a disconnection.

Failover can also be provided for the engine tier nodes. As previously discussed, the engine tier nodes can periodically poll the state tier nodes in order to determine which timer objects it needs to execute. In turn, the state tier nodes can notice whenever the engine tier node has failed to poll. If a specified period of time elapses and the engine tier has not polled the state tier, the state server can then report that engine as unavailable (e.g. having failed or disconnected from the network). In this manner, failover can be implemented for both the state tier and the engine tier, thereby providing a more reliable and secure cluster for message processing.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the machine readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing systems and methods for providing the SIP server architecture as discussed herein.

Various embodiments may be implemented using a conventional general purpose or specialized digital computer(s) and/or processor(s) programmed according to the teachings of the present disclosure, as can be apparent to those skilled in the computer art. Appropriate software coding can readily be prepared by skilled programmers based on the teachings of the present disclosure, as can be apparent to those skilled in the software art. The invention may also be implemented by the preparation of integrated circuits and/or by interconnecting an appropriate network of conventional component circuits, as can be readily apparent to those skilled in the art.

Embodiments can provide, by way of example and without limitation, services such as:

VoIP services, including, without limitation the following features:

Basic features. These include standards services such as Voice mail, Caller ID, Call waiting, and call forwarding (the ability to forward a call to a different number).

Advanced features. Following is a brief list of advanced features:

Call logs: The ability to view calls made over a given period of time online, ability to associate names with phone numbers, integrate call log information to other applications such as IM.

Do not disturb: The ability to specify policies around receiving calls—for example, all calls during office hours to be automatically forwarded to a mobile terminal, all calls during the night to be directed to voice mail etc.

Locate me: This is advanced call forwarding. Rather than have all calls forwarded to a single location (e.g., voice mail) when the caller is busy, Locate me can try multiple terminals in series or in parallel. For example, a user may have two office locations, a mobile, and a pager, and it may make sense to forward a call to both office locations first, then the pager, and then the mobile terminal. Locate me is another example of feature interaction.

Personal conferencing: A user could use an existing application (e.g., IM client) to schedule a Web/audio conference to start at a certain time. Since the IM client already has personal profile information, the conferencing system sends out the Web conference link information either through IM and/or email to the participants. The phone contact information in the profile is used to automatically ring the participants at the time of the conference.

Lifetime number: This is the facility where a single virtual number can travel with a customer wherever they live. Even if they move, the old number continues to work, and reaches them at their new location. This is really the analog of static IP addresses in a phone network.

Speed dial: This is the ability to dramatically expand the list of numbers that can be dialed through short-key and accelerator combinations. This is another example of a converged application, since it's very likely that when a user will set up this information when they work through the call logs on the operator user portal, and the updated information needs to be propagated to the network side in real-time.

Media delivery services, including, without limitation the following features:

Depending on the service level agreement users are willing to sign up to, the quality of media delivered (e.g. number of frames per second) will vary. The policy engine enables segmenting the customer base by revenue potential, and to maximize return on investment made in the network.

Context-sensitive applications including, without limitation the following features:

A typical example here is the need for applications that have a short lifetime, extremely high usage peaks within their lifetime, and immediacy. For example, voting on American Idol during the show or immediately afterwards has proved to be an extremely popular application.

Integrated applications including, without limitation the following features:

The final class of applications is one that combines wireline and wireless terminal usage scenarios. An example of an integrated application is the following: a mobile terminal user is on a conference call on their way to work. When he reaches his office, he enters a special key sequence to transfer the phone call to his office phone. The transfer happens automatically without the user having to dial in the dial-in information again. It's important to note hear that this capability be available without the use of any specific support from the hand-set (a transfer button for example).

Various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A system for improving latency in message processing for a network environment, comprising:
an engine tier distributed on a cluster network and adapted to maintain short lived data objects;
a state tier distributed on the cluster network and adapted to maintain long lived data objects; and
a message received to the cluster network and processed by the engine tier wherein the engine tier retrieves a set of long lived objects from the state tier and employs them as short lived objects on the engine tier while processing the message.

2. The system of claim 1 wherein the engine tier pushes the set of long lived objects back to the state tier after employing them for message processing; and
wherein the long lived objects are removed from the engine tier after pushing them back to the state tier.

3. The system of claim 1, further comprising:
a partition located in the state tier, the partition including one or more state replicas for storing duplicate state thereon.

4. The system of claim 3, further comprising:
an engine node located in the engine tier, the engine node adapted to communicate with the partition such that the engine node is capable of retrieving the set of long lived objects from any state replica within the partition.

5. The system of claim 4 wherein the engine node attempts to retrieve the set of long lived objects from a first state replica, determines that the first state replica is busy performing garbage collection and retrieves the set of long lived objects from a second state replica.

6. The system of claim 1 wherein the engine tier continues to process messages while simultaneously garbage collecting the short lived objects and wherein the state tier stops processing requests in order to garbage collect the long lived objects.

7. The system of claim 1 wherein the message is a session initiated protocol (SIP) message originated by at least one of a phone, a wireless device and an application.

8. The system of claim 1 wherein the state tier maintains session initiation protocol (SIP) state data including timer objects for retransmitting messages to SIP clients.

9. The system of claim 1 further comprising:
a load balancer coupled to the cluster network and adapted to receive the message and distribute it to an appropriate engine for processing.

10. The system of claim 1 wherein the short lived objects are localized to a thread such that a garbage collector is capable of removing the short lived objects without interfering with execution of other threads.

11. A computer implemented method for improving latency in message processing, comprising:
maintaining an engine tier on a network cluster, wherein the engine tier processes incoming messages and stores short lived objects;
maintaining a state tier on the network cluster wherein the state tier stores long lived objects that are used in processing the incoming messages;
receiving an incoming message;
retrieving one or more long lived objects from the state tier into the engine tier and employing them as one or more short lived objects in the engine tier;
processing the incoming message by an engine in the engine tier; and
pushing the one or more long lived objects from the engine tier back to the state tier.

12. The method of claim 11, further comprising:
removing the one or more long lived objects from the engine tier after they have been pushed back onto the state tier.

13. The method of claim 11 wherein the long lived objects in the state tier are maintained in partitions, each partition including one or more state replicas for storing duplicate state data thereon.

14. The method of claim 13 wherein engines in the engine tier are adapted to communicate with the partitions such that each engine can access the long lived objects from any state replica in the partition.

15. The method of claim 14 further comprising:
attempting to retrieve the long lived objects from a first state replica in the partition;
determining that the first state replica is busy performing garbage collection; and
retrieving the long lived objects from a second state replica in the partition.

16. The method of claim 11 wherein the engine tier continues to process messages while simultaneously garbage collecting the short lived objects and wherein the state tier stops processing requests in order to garbage collect the long lived objects.

17. The method of claim 11 wherein the message is a session initiated protocol (SIP) message originated by at least one of a phone, a wireless device and an application.

18. The method of claim 11 wherein the state tier maintains session initiation protocol (SIP) state data for specifying at least one of caller identification, callee identification, type of application, type of message and when to fire a timer object.

19. The method of claim 11 wherein receiving an incoming message further comprises:
receiving the message by a load balancer coupled to the cluster network and distributing it to an engine in the engine tier as determined by the load balancer.

20. A computer-readable medium having instructions stored thereon which when executed by one or more processors cause a system to:
maintain an engine tier on a network cluster, wherein the engine tier processes incoming messages and stores short lived objects;
maintain a state tier on the network cluster wherein the state tier stores long lived objects that are employed in processing the incoming messages;
receive an incoming message;
retrieve one or more long lived objects from the state tier into the engine tier and use them as one or more short lived objects in the engine tier;
process the incoming message by an engine in the engine tier; and
push the one or more long lived objects from the engine tier back to the state tier.
